(19) United States
(12) Patent Application Publication
(10) Pub. No.: US 2005/0184643 A1
(43) Pub. Date: Aug. 25, 2005

(54) Method for forming electron emission source for electron emission device and electron emission device using the same

(76) Inventors: Sung-Hee Cho, Suwon-si (KR); Jong-Hwan Park, Suwon-si (KR); Sang-Hyun Lee, Yongin-si (KR)

Correspondence Address: CHRISTIE, PARKER & HALE, LLP, PO BOX 7068, PASADENA, CA, 91109-7068, US

(21) Appl. No.: 11/066,854

(22) Filed: Feb. 24, 2005

(30) Foreign Application Priority Data
Feb. 25, 2004 (KR) 10-2004-0012635

(51) Int. Cl. H01J 1/62

(52) U.S. Cl. 313/495

(57) ABSTRACT

The present invention relates to a method for forming an electron emission source for an electron emission device and an electron emission device produced by the method. The method for forming an electron emission source comprises: depositing at least one kind of charged particles selected from the group consisting of carbon-based materials, metal particles, inorganic particles, and organic materials to a substrate charged by the opposite charge. The method provides an electron emission source for an electron emission device upon which carbon nanotubes are selectively deposited in a desired pattern without leaving surplus organic carbon. The resulting electron emission devices exhibit excellent life and electron emission characteristics. The method does not require additional surface treatment.

### CROSS REFERENCE TO RELATED APPLICATION

This application claims priority to and the benefit of Korean Patent Application No. 10-2004-0012635 filed on Feb. 25, 2004 in the Korean Intellectual Property Office, the entire content of which is incorporated herein by reference.

### FIELD OF THE INVENTION

The present invention relates to a method for forming an electron emission source for an electron emission device, and an electron emission device made by the method. More particularly, the present invention relates to a method for forming an electron emission source for an electron emission device that is capable of selectively depositing carbon nanotubes in a desired pattern by simple procedures without leaving surplus organic carbon and without requiring additional surface treatment. The invention further relates to an electron emission device formed by the method. Such an electron emission devise has excellent life characteristics and electron emission characteristics.

### BACKGROUND OF THE INVENTION

Generally, an electron emission device such as a field emission display device produces the desired images by emitting electrons from an electron emission source provided on a cathode electrode using tunneling effects of quantum theory, and colliding the emitted electrons against a fluorescent layer provided on an anode electrode thereby emit light. A triode structure having a cathode electrode, a gate electrode, and an anode electrode is widely used as such device.

As the configuration of the electron emission source, a plane type in which the source is evenly formed on the cathode electrode is typically used instead of a conventional spindt type in which the source is pointed at the end. The plane type electron emission source is formed through the steps of applying carbon-based material such as carbon nanotubes or graphite on the cathode electrode using a thick film coating process such as screen printing, and firing the applied material. In comparison with the spindt type electron emission source, the plane type electron emission source is advantageous in that it's a manufacturing process that is simpler and capable of producing a large-scale display.

To form the carbon nanotubes in the triode structure, conventional methods have pasted the carbon nanotubes or selectively formed a carbon nanotube pattern along with a photosensitive agent using a slurry method. However, according to such a method, surplus organic carbon that is mixed with the carbon nanotubes is not completely removed by firing in a nitrogen atmosphere. Such surplus carbon reduces the degree of vacuum in a vacuum device and can result in shortened life for the electron emission source. In addition, since the carbon nanotubes are not exposed and do not lie down because of this surplus organic carbon, there is a problem in that the carbon nanotubes have to be vertically arranged by an additional surface treatment step.

### SUMMARY OF THE INVENTION

According to one embodiment of the present invention a method for forming an electron emission source for an electron emission device is provided that is capable of overcoming the above drawbacks associated with conventional methods. The method permits the selective deposition of carbon nanotubes in a desired pattern without leaving surplus organic carbon and does not require an additional surface treatment step. This is achieved by charging the substrate and charging the particles with an opposite charge before depositing the charged particles to the substrate.

In one embodiment of the present invention an electron emission source is provided according to the above-identified method.

In yet another embodiment of the present invention a method for forming an electron emission device is provided that is capable of producing a large-scale display with excellent life characteristics and electron emission characteristics.

### BRIEF DESCRIPTION OF THE DRAWINGS

FIG. 1 is a partial cross-sectional view of an electron emission device according to the present invention;

FIGS. 2a to 2g are schematic views in which a method for forming the electron emission source according to the present invention is explained in sequence;

FIG. 3 shows a scanning electron microscope (SEM) photograph of powder in which carbon nanotubes, solid glass frit powder, metal particles, and an organic binder are provided in a mixed form to perform electrostatic coating according to an example of the present invention; and

FIG. 4 shows a view comparing electron emission (I-V) characteristics of the electron emission source formed by Example 1 compared to the electron emission source of the prior Comparative Example 1.

### DETAILED DESCRIPTION OF THE PREFERRED EMBODIMENTS

According to one embodiment of the present invention a method for forming an electron emission source is provided comprising the step of depositing at least one kind of charged particles selected from the group consisting of carbon-based materials, metal particles, inorganic particles, and organic materials to a substrate charged by an opposite charge.

According to another embodiment of the present invention an electron emission source is provided that is formed by the above-mentioned method.

An electron emission device according to an embodiment of the present invention comprises first and second substrates arranged opposed to and spaced from one another by a predetermined distance and bonded to one another with sealing materials to form a vacuum vessel. Cathode electrodes are formed on the first substrate, and an electron emission source in contact with the cathode electrodes is formed on the first substrate by deposition. Gate electrodes are formed on the first substrate with an insulating layer formed between the cathode electrodes and the gate electrodes. An anode electrode is formed on the second substrate with a fluorescent screen located in one side of the anode electrode.

According to one embodiment of the present invention a method for manufacturing an electron emission device comprises: (a) forming cathode electrodes on an upper part of a transparent first substrate; (b) forming an insulating layer on a whole surface of the first substrate, forming a gate layer on the insulating layer, and then forming holes penetrating the gate layer and the insulating layer; and (c) forming an electron emission source by depositing and firing at least one kind of charged particle selected from the group consisting of carbon-based materials, metal particles, inorganic particles, and organic materials to the first substrate charged by an opposite charge.

Hereinafter, the invention will be explained in more detail.

According to one embodiment of the present invention, carbon nanotubes, metal particles, and inorganic particles are charged with negative electric charges, and then selectively deposited onto desired positions of a substrate charged with positive electric charges. The charges cause the carbon nanotubes and the metal particles to remain on the substrate forming a laminated structure during deposition, eliminating the need for surface treatment to raise the carbon nanotubes.

According to this method, negative charges are imparted on the carbon nanotubes and the metal particles without using an organic constituent. The negative electric charges cause the carbon nanotubes and metal particles to attach to the substrate which has positive electric charges. In this way, the carbon nanotubes are deposited in a raised fashion between the metal particles. These carbon nanotubes can be used as the electron emission source without an additional surface treatment step required after firing. Further, this method can uniformly deposit the carbon nanotubes on a large-size substrate regardless of the size of the substrate, and it can selectively deposit the carbon nanotubes on the desired pattern without leaving surplus organic carbon and without requiring the additional surface treatment.

According to the present invention, it is preferred to eject the carbon nanotubes and the metal particles as they are charged by negative electric charges using an electrostatic coating method. To deposit the substrate selectively, only portions at which the deposition is required are deposited using a photoresist sacrificial layer (a layer for flattening a surface of a metallic film) after opening a photoresist.

The invention may also use another metal protection layer or an organic protection layer in addition to the photoresist sacrificial layer.

In forming the electron emission source of the invention, first, the metal particles or the inorganic particles are charged and deposited on the substrate, and then the carbon nanotubes charged by negative electric charges are deposited on the substrate upon which the metal particles have already been deposited. After that, another layer of metal particles or inorganic particles is thinly deposited while controlling the film thickness. Carbon nanotubes are then deposited on the substrate again. By repeating the above procedure, the carbon nanotube electron emission source is formed in a fashion such that the carbon nanotubes are raised or stuck between the metal particles. After that, adherence is imparted to the substrate by pre-firing, and then adherence is generated between the substrate and the metal particles by removing a photoresist that is a sacrificial layer and performing a firing process. Therefore, the CNT electron emission source produced according to this method can be selectively formed at a desired portion. Here, the carbon nanotubes do not include the organic materials or the surplus carbon, but they include the metal particles or the inorganic particles. This method does not require an additional surface treatment step for raising the carbon nanotubes, and provides a device with long life characteristics due to the absence of the surplus carbon.

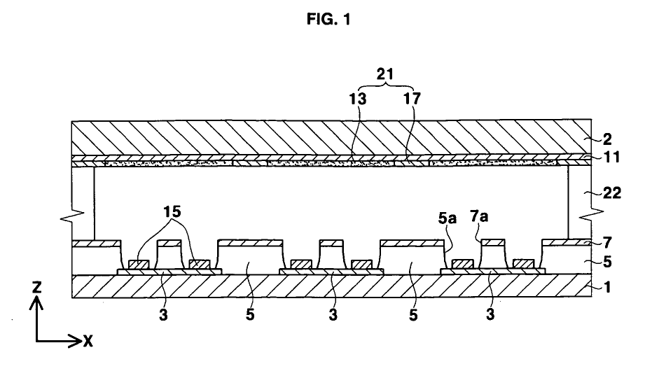

An embodiment of the present invention is now described with reference to the drawings. FIG. 1 is a partial cross-sectional view showing an electron emission device of a field emission display according to one example of the present invention.

Referring to FIG. 1, an electron emission is formed into a vacuum container by spacing a first substrate (or cathode substrate) 1 and a second substrate (or anode substrate) 2 a predetermined distance from one another in a substantially parallel arrangement and sealing the two to one another to form a vacuum container with an internal space. In the vacuum container, an electron emission source that can emit electrons is formed on the first substrate 1. A light emitting portion is provided that can display predetermined images by emitting light when the electrons emitted from the electron emission source collide with the second substrate 2. The configuration of this light emitting portion can be composed as below as an example.

The electron emission source includes cathode electrodes 3, insulating layers 5, and gate electrodes 7 on the first substrate 1, and an anode electrode 11 and fluorescent layers 13 on the second substrate 2. The cathode electrodes 3 and the gate electrodes 7 are formed in stripe patterns perpendicular to each other. Holes 5a and 7a penetrating the gate electrodes 7 and the insulating layers 5 are formed at the crossed areas of the cathode electrodes 3 and the gate electrodes 7. Then, an electron emission source 15 is placed at the surfaces of the cathode electrodes 3 exposed by the holes 5a and 7a.

The thickness of the insulating layer 5 is roughly 20 μm. The insulating layer 5 with this thickness is formed by several repetitions of processes in which dielectric paste is thick-film-printed, dried, and fired. The dielectric paste forming the insulating layer can be an ordinary composition. Preferably, the composition of the dielectric paste can include an oxide such as SiO₂, PbO, or TiO₂, provided in an ordinary solvent.

The gate electrodes 7 are made in a stripe shape that is perpendicular to the cathode electrodes 3 by depositing metallic materials on the insulating layers 5 and patterning them. Then, the holes 5a and 7a penetrating the gate electrodes 7 and the insulating layers 5 are formed at the crossed areas of the cathode electrodes 3 and the gate electrodes 7 using an ordinary photolithography process.

In one embodiment of the present invention, a method of making the electron emission source after forming the holes penetrating the gate layers and the insulating layers is as follows.

The method of forming the electron emission source of the present invention does not use conventional general paste composites. Rather, it includes a step of depositing particles with one or more kinds of electric charges selected from the group consisting of the carbon-based materials, metal particles, inorganic particles, and organic substances to a substrate having the opposite electric charges.

At this time, since carbon-based particles with electric conductivity are formed over the cathode electrode 3 and the gate electrode 7 and as such a short between two electrodes may occur, the electron emission source 15 may be formed by selectively using a sacrificial layer to prevent this electrode short. That is, it is preferred that the substrate includes a photoresist sacrificial layer, another metallic protection layer, or an organic protection layer. However, the present invention is not necessarily limited to this, and it is possible to make the field emission display without forming the sacrificial layer as described above.

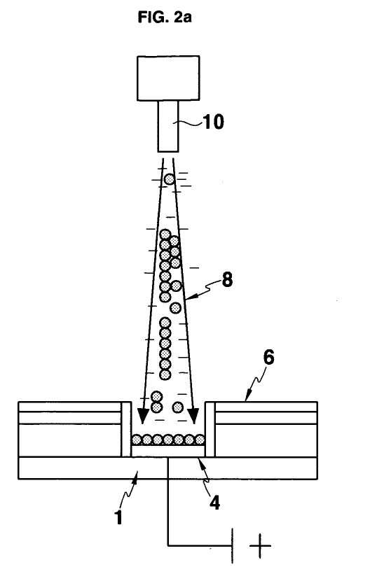

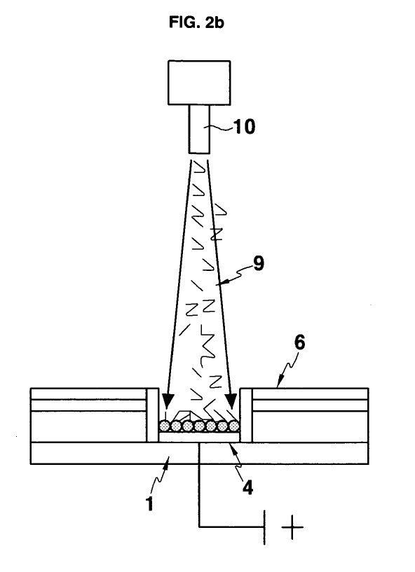

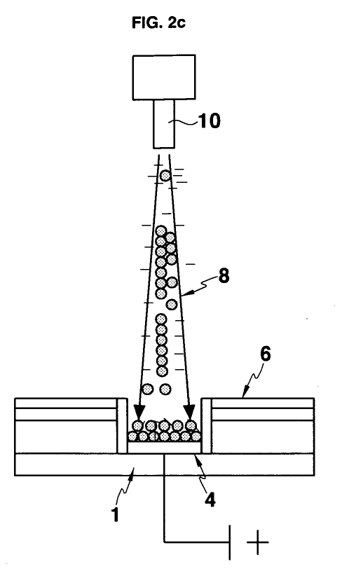

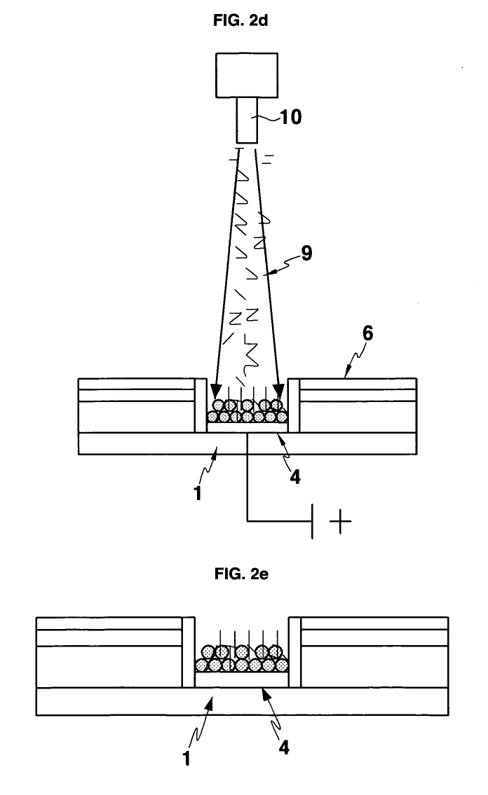

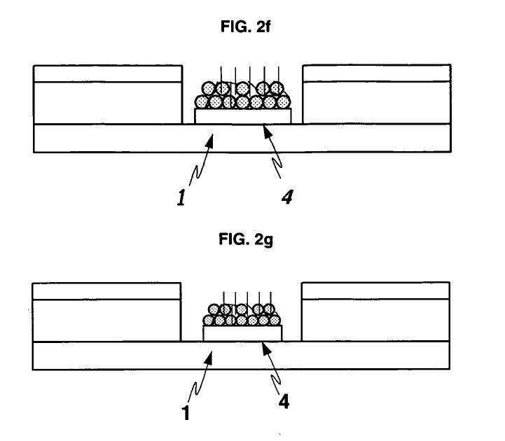

More preferably, the method of forming the electron emission source in the present invention includes a step using the sacrificial layer as shown in FIG. 2a to FIG. 2g.

FIG. 2a to FIG. 2g are schematic views showing a process in which the electron emission source is formed on a triode substrate by using an electrostatic coating method according to an example of the present invention. In FIG. 2a to FIG. 2g, a positively charged glass substrate 1 is provided with an ITO transparent electrode 4 formed on it with a photoresist sacrificial layer 6. Electrostatically charged metal and inorganic particles 8 and electrostatically charged CNT or other carbon particles 9 are produced from a negative electrode particle generator 10. Alternatively, the substrate may be negatively charged if the electrostatic particle generator produces particles with a positive polarity. An ordinary electrostatic particle generator may be used for the coating process.

Referring to FIG. 2a to FIG. 2g, the electron emission source in the present invention is formed by (a) depositing the metal particles and the inorganic particles with negative electric charges by the electrostatic particle generator to the substrate with positive electric charges; (b) depositing the carbon nanotubes or the carbon-based materials thereupon; (c) depositing the metal particles or the inorganic particles thereupon; (d) depositing the carbon nanotubes or the carbon-based materials thereupon; (e) performing a pre-firing process; (f) performing a photoresist sacrificial layer stripping process; and (g) performing a firing process.

These processes are illustrated in further detail below.

According to the present invention, the carbon nanotubes (CNTs), the metal particles, and the inorganic particles are negatively chared by the electrostatic particle generator using a principle of electrostatic coating process. Then, the charged particles are uniformly sprayed on the positively charged substrate by a coating method. The substrate for selective coating is patterned so that the material is deposited to only the exposed portions using the photoresist as a sacrificial layer.

In depositing the metal particles and CNTs, first the metal particles are deposited, and then the CNTs or the inorganic particles are deposited. Then, the metal particles are deposited again more thinly and sparsely than the first time. Lastly, the CNTs are deposited again by the same method.

The CNTs remain as raised forms or well-defined forms on the surface among the metal particles or the inorganic particles by using this sequential method.

Thereafter, remaining materials of non-deposited portions are removed by generating adherence between the CNTs and the substrate by pre-firing at about 120° C. and then eliminating the photoresist sacrificial layer.

The sacrificial layer may be formed throughout the first substrate 1 surface. An ordinary photolithography process removes some parts of the sacrificial layer on the upper cathode electrodes 3. In the present invention, the photolithography process is not limited to the above method, and a screen printing method can also be used.

Finally, the CNT electron emission source is completed by firing the area in which the remaining materials have been removed under a nitrogen atmosphere at about 450° C. to cause adherence among the metal particles, the CNTs, and the substrate.

It is preferred that the particles with electric charges have sizes of 1 nm to 100 μm. The coating process is not performed properly if the particle sizes are less than 1 nm, and the particle patterning in the triode is difficult if the particle sizes are more than 100 μm.

The polarities of the particles deposited on the substrate and static electricity of the substrate constitute negative polarity or positive polarity. At this time, the charged particles have negative electric charges if the substrate has a positive electric charge, and the substrate has negative electric charges if the charged particles have a positive charge. Moreover, the method works better when the positive or negative electric charges are given from a state of zero electric charge.

Also, the deposit order of the particles deposited on the substrate can be performed irrespective of the kinds of particles. That is, the CNTs, the inorganic particles, and so on can be mixed and it is possible to deposit regardless of the order. For example, the deposited order of the particles with electric charges to the substrate can be performed in the order of: the metal particles, the carbon series, the metal particles, and carbon series. However, it is not limited to this order.

It is preferred that the one or more kinds of the carbon-based materials are selected from the group consisting of carbon nanotubes, graphite, diamond, diamond-like carbon, and C₆₀ (fullerene). It is preferred that the one or more kinds of the metal particles are selected from the group consisting of Ag, Cu, Fe, Al, In, and Pt. It is preferred that the one or more kinds of the inorganic particles are selected from the group consisting of a frit series, SiO₂, PbO, and TiO₂. It is preferred that the one or more kinds of the organic materials are selected from the group consisting of ethyl cellulose (EC) resin and acrylate resin.

The electron emission source 15 formed as above emits electrons according to a field distribution made between the cathode electrodes 3 and the gate electrodes 7 by an impressed voltage from outside of the vacuum container to the cathode electrodes 3 and the gate electrodes 7.

The cathode electrodes 3 are formed along one direction of the first substrate 1 by adopting a predetermined pattern such as in the stripe fashion. The insulating layers 5 are arranged over the first substrate 1 while covering the cathode electrodes 3.

On the insulating layers 5, the plurality of gate electrodes 7 having the holes 5a penetrating the insulating layers 5 and the holes 7a penetrating the gate electrodes 7 are formed. These gate electrodes 7 are formed at any interval in the direction perpendicular to the cathode electrodes 3 while maintaining the stripe fashion.

In comparison with this configuration of the electron emission source, a configuration of the light emitting portion includes the anode electrode 11 formed at the one side of the second substrate 2, which is opposite to the first substrate, and R, G, B fluorescent films 13 formed on this anode electrode 11.

That is, the anode electrode is formed at the side of the second substrate 2 facing the first substrate 1. Then, a fluorescent screen 21 composed of the fluorescent films and a black layer 17 is formed at one side of the anode electrode. The anode electrode is equipped with a transparent electrode such as indium tin oxide (ITO). On the other hand, a metallic film, which is not shown, increasing brightness of the screen by a metal back effect may be located on a surface of the fluorescent screen. In this case, the metallic film can be used as the anode electrode while omitting the transparent electrode.

The plural anode electrodes 11 are formed at any interval on the second substrate 2 by maintaining the stripe pattern that is longitudinally arranged in a direction parallel to a length direction of the cathode electrodes 3. The fluorescent films 13 can be formed on the anode electrode 11 through manufacturing methods of electrophoresis, screen printing, spin coating, and so on.

If the method of the present invention described above is used, the carbon nanotubes can be selectively deposited to desired portions with a combination of only the CNTs, the metal particles, and the inorganic particles under a condition such that surplus organic carbon does not remain in a c-FED triode structure. Electron emission sites can also be formed uniformly without performing additional surface treatment to raise the CNTs thereafter. This method can basically play a very important role in securing a long life of a vacuum display because solvents or resins of organic ingredients such as conventional pastes or slurry composites are not used. Moreover, it is easy to make a large area for a large display.

Hereinafter, the preferred examples and comparative examples of the present invention are disclosed. The below examples are only stated to express certain embodiment of the present invention more precisely. Consequently, the content of the present invention is not limited to the below examples.

### EXAMPLE 1

10 g of the CNTs having 2-3 μm in diameter, 30 g of Ag as the metal particles having 1 μm in diameter, 20 g of the glass frit as the inorganic particles having 1 μm in diameter, and 40 g of a high molecular resin (isobutylmethacylate) were mixed to generate negative electric charges by using the electrostatic particle generator as shown in FIG. 2a according to the electrostatic coating principle. Then, the charged particles were uniformly sprayed on the positively charged substrate by a coating method. At this time, the substrate for the selective coating was patterned so that particles would only be deposited on selected portions by using the photoresist as the protection layer.

The metal particles were first deposited and then the CNT particles were deposited thereon. Then, the metal particles were deposited again more thinly and sparsely than the first time. Lastly, the CNTs were deposited by the same method. The CNTs remain as raised forms or well-defined forms on the surface among the metal particles or the inorganic particles by using this sequential method.

After that, the remaining materials of non-deposited portions were removed by pre-firing the result at 120 ° C and by eliminating the photoresist sacrificial layer. Finally, the electron emission source was formed by adhering the metal particles, the CNTs, and the substrate through firing under a nitrogen atmosphere at 450° C.

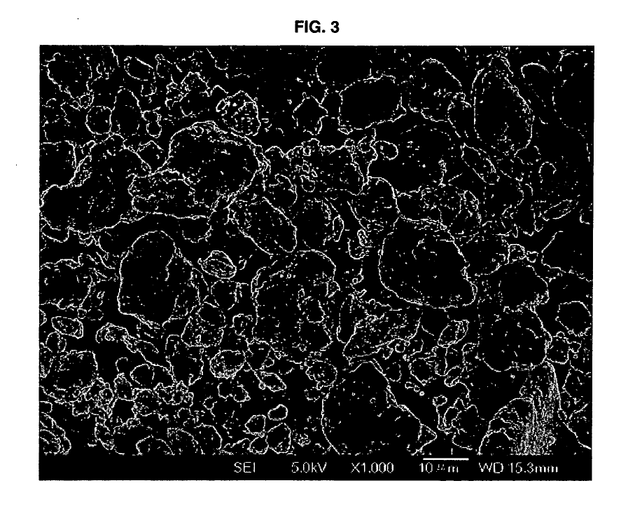

A Scanning Electron Microscopy (SEM) photograph of powder that was a mixed form of the carbon nanotubes, solid powder of the glass frit, the metal particles, and organic binders prepared to perform the electrostatic coating according to one example of the present invention is shown in FIG. 3.

### COMPARATIVE EXAMPLE 1

3 g of the CNTs and 0.8 g of the glass frit were mixed after determining their quantities. Then, a vehicle was obtained by mixing 15 g of a photosensitive monomer, 8 g of a photo-initiator, 15 g of terpineol as a solvent, and 60 g of acrylate resin as the organic binder resin. Thereafter, a paste composite was produced by mixing the vehicle and the mixture containing the carbon nanotubes. This paste composite was heat-treated at 90° C. for 10 minutes after performing screen printing with a printer. Then, it was exposed with an exposure machine of parallel light (exposure energy: 10 to 20000 mJ/cm²) and developed by a spray method using an alkali solution. Hereafter, the electron emission source was obtained by firing in a firing machine at 450° C. to 550° C. and by performing surface treatment of the CNT films.

### EXPERIMENTAL EXAMPLE

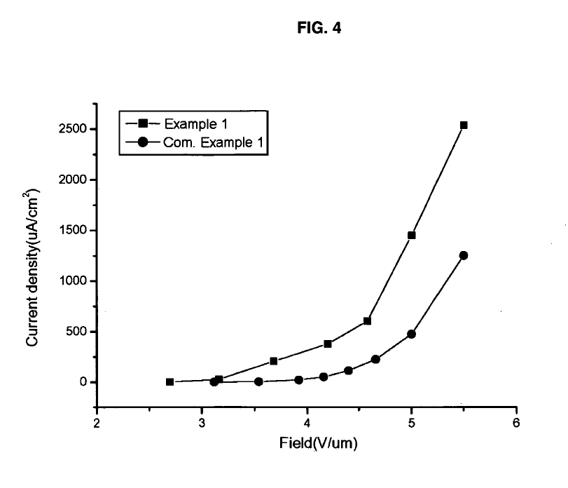

Concerning Example 1 and Comparative Example 1, the amount of electric current about the electron emission source was measured by a diode method. FIG. 4 shows a comparison of electron emission (I-V) characteristics of the electron emission source formed according to Example 1 of the present invention and the electron emission source of the conventional Comparative Example 1.

As shown in FIG. 4, the density of emitted electric current for the electron emission source formed through the coating by the electrostatic coating method of Example 1 of the present invention increased by more than 3 times at 5 V/um over a standard CNT electron emission source coated by the printing method using the conventional paste of Comparative Example 1. It is known that an operating voltage to obtain the same density of electric current (200 uA/cm²) can be also reduced more than 1 V/um. That is, the method of the present invention makes the formation of the CNT electron emission source with all the advantages in the density of emitted electric current, the operating voltage, the life, and the large-scale structure possible.

Furthermore, surplus carbon did not remain for Example 1 of the present invention. However, a ratio of surplus organic carbon in Comparative Example 1 was shown as 10%.

As seen above, the present invention enables the carbon nanotubes to be deposited to selectively desired patterns without leaving surplus organic carbon. Then, the electron emission source with superior life and electron emission characteristics can be formed by the simple method without needing the additional surface treatment to raise the CNTs. Finally, the electron emission device exhibits superior life and the electron emission characteristics when made using this electron emission source.

While the present invention has been described in detail with reference to the preferred embodiments, those skilled in the art will appreciate that various modifications and substitutions can be made thereto without departing from the spirit and scope of the present invention as set forth in the appended claims.

1. A method of forming an electron emission source, comprising: depositing a plurality of charged particles selected from the group consisting of carbon-based materials, metal particles, inorganic particles, organic materials, and combinations thereof to a substrate charged by an opposite charge.

2. The method according to claim 1, wherein the charged particles are from about 1 nm to 100 μm in diameter.

3. The method according to claim 1, wherein the charged particles are charged by an electrostatic particle generator to a polarity selected from negative polarity and positive polarity.

4. The method according to claim 1, wherein the depositing step includes depositing two or more kinds of charged particles sequentially.

5. The method according to claim 1, wherein the charged particles are carbon-based materials selected from the group consisting of carbon nanotubes, graphite, diamond, diamond-like carbon, C₆₀ (fullerene), and combinations thereof.

6. The method according to claim 1, wherein the charged particles are metal particles selected from the group consisting of Ag, Cu, Fe, Al, In, Pt, and combinations thereof.

7. The method according to claim 1, wherein the charged particles are the inorganic particles selected from the group consisting of frit series, SiO₂, PbO, and TiO₂, and combinations thereof.

8. The method according to claim 1, wherein the charged particles are the organic materials selected from the group consisting of an ethyl cellulose (EC) resins, an acrylate resins, and combinations thereof.

9. The method according to claim 1, wherein the substrate is coated with one or more layers selected from a photoresist sacrificial layer, a metal protection layer, and an organic protection layer.

10. The method according to claim 9 wherein the substrate is coated with a photoresist sacrificial layer, the method further comprising:
forming a first layer by depositing a combination metal particles and inorganic particles charged with negative charges by an electrostatic particle generator to the positively charged substrate;
forming a second layer by depositing carbon-based materials on the first layer;
forming a third layer by depositing a combination of metal particles and inorganic particles on the second layer;
forming a fourth layer by depositing carbon-based materials on the third layer;
performing a pre-firing process;
a stripping the photoresist sacrificial layer; and
a firing the layered substrate.

11. An electron emission source for an electron emission device formed by the method according to claim 1.

12. An electron emission device comprising: first and a second substrates arranged opposite to one another and spaced apart from one another by a predetermined distance and bonded with sealing materials to form a vacuum vessel; cathode electrodes formed on the first substrate; an electron emission source contacting the cathode electrodes and formed on the first substrate by deposition; gate electrodes formed on the first substrate; an insulating layer formed between the cathode electrodes and the gate electrodes; an anode electrode formed on the second substrate; and a fluorescent screen located on one side of the anode electrode, wherein the electron emission source is formed by depositing at least one kind of charged particles selected from the group consisting of carbon-based materials, metal particles, inorganic particles, and organic materials to the first substrate charged by the opposite charge.

13. The electron emission device according to claim 12, wherein the charged particles are from 1 μm to 100 μm in diameter.

14. The electron emission device according to claim 12, wherein the charged particles are the carbon-based materials selected from the group consisting of carbon nanotubes, graphite, diamond, diamond-like carbon, C₆₀ (fullerene), and combinations thereof.

15. The electron emission device according to claim 12, wherein the charged particles are the metal particles selected from the group consisting of Ag, Cu, Fe, Al, In, Pt, and combinations thereof.

16. The electron emission device according to claim 12, wherein the charged particles are the inorganic particles selected from the group consisting of frit series, SiO₂, PbO, TiO₂, and combinations thereof.

17. The electron emission device according to claim 12, wherein the charged particles are the organic materials selected from the group consisting of an ethyl cellulose (EC) resins, an acrylate resins, and combinations thereof.

18. A method for manufacturing an electron emission device, comprising:
forming cathode electrodes on an upper part of a transparent first substrate;
forming an insulating layer on a whole surface of the first substrate and forming a gate layer on the insulating layer, and then forming holes penetrating the gate layer and the insulating layer; and
forming an electron emission source by depositing and firing a plurality of charged particles selected from the group consisting of carbon-based materials, metal particles, inorganic particles, organic materials, and combinations thereof, to the first substrate charged by the opposite charge.

19. The method according to claim 18, wherein the charged particles are from 1 nm to 100 μm in diameter.

20. The method according to claim 18, wherein the charged particles are the carbon-based materials selected from the group consisting of carbon nanotubes, graphite, diamond, diamond-like carbon, C₆₀ (fullerene), and combinations thereof.

21. The method according to claim 18, wherein the charged particles are the metal particles selected from the group consisting of Ag, Cu, Fe, Al, In, Pt, and combinations thereof.

22. The method according to claim 18, wherein the charged particles are the inorganic particles selected from the group consisting of a frit series, SiO₂, PbO, TiO₂, and combinations thereof.

23. The method according to claim 18, wherein the charged particles are the organic materials selected from the group consisting of an ethyl cellulose (EC) resins, an acrylate resin, and combinations thereof.
